(19) United States
(12) Patent Application Publication
(10) Pub. No.: US 2026/0197190 A1
(43) Pub. Date: Jul. 9, 2026

(54) GENERATIVE AI-ASSISTED CERTIFICATE LIFECYCLE MANAGEMENT, PENETRATION TESTING, AND ON-DEMAND CUSTOMIZED KEY ROTATION FOR ENHANCED SECURITY

(71) Applicant: Anupam Kakkar, Ottawa (CA)

(72) Inventor: Anupam Kakkar, Ottawa (CA)

(21) Appl. No.: 19/008,949

(22) Filed: Jan. 3, 2025

(51) Int. Cl. H04L 9/40; H04L 9/08; H04L 9/32; H04L 41/16

(52) U.S. Cl. CPC H04L 9/40; G06F 21/50; G06F 21/577; H04L 9/0825; H04L 9/3268; H04L 41/16

(57) ABSTRACT

A system for automating the lifecycle of SSL certificate management, comprising: a memory unit for storing machine-readable instructions, and a processor configured to execute the instructions, enabling AI-guided user interactions for filing Certificate Signing Requests (CSR), error detection and correction, submission, and optimization of CSR for enhanced security. The system further includes AI-based mechanisms for detecting server environments, optimizing SSL configurations, secure installation of certificates, and performing penetration testing to identify vulnerabilities. The system continuously monitors SSL certificate status, applies proactive updates or renewals based on detected threats, performs on-demand key rotation, and facilitates SSL certificate management across multi-cloud and hybrid infrastructures through an integrated AI-powered dashboard, eliminating manual processes, enhancing security, ensuring proactive management, and improving accessibility.

### BACKGROUND

Embodiments of the present invention generally relate to Generative AI-assisted SSL certificate lifecycle management, which automates the entire SSL lifecycle. It improves security by using AI to detect vulnerabilities and optimize configurations. The system reduces manual errors, delays, and security risks, making SSL management more efficient and accessible for all users.

The present invention relates to the fields of Artificial Intelligence (AI), Machine Learning (ML), and Cyber security, with a specific focus on SSL/TLS certificate management. More particularly, the invention provides an AI-assisted platform designed to optimize and automate the entire lifecycle of SSL/TLS certificate issuance, management, and renewal.

Available existing technologies and services address various aspects of SSL/TLS certificate issuance, installation, and management. However, these solutions fall short in addressing the complexity and fragmentation of the SSL lifecycle.

SSL/TLS Certificate Authorities (CAs) are key players in the process of issuing and managing SSL certificates, which are essential for securing online communications. These authorities provide SSL certificates that encrypt data transmitted over the internet. While CAs automate certain aspects of the certificate issuance process, such as domain ownership validation, they still rely heavily on manual intervention for several steps. For instance, users are typically required to manually install and configure the certificates on their servers. They also need to manage ongoing renewals, security updates, and configurations, which are often done manually or through limited automation.

One key limitation of most CAs is that they do not offer AI-assisted features to streamline these tasks. For example, SSL renewals typically require human intervention to track expiration dates and initiate the renewal process. Similarly, security updates are usually implemented manually or via basic automated notifications, which do not actively monitor or respond to evolving security threats. This lack of AI-driven automation results in time-consuming processes and increases the risk of human error, which can lead to expired certificates or overlooked security vulnerabilities.

Furthermore, some solutions provide free automated SSL certificates, but users still face challenges. These solutions require users to manually set up ACME clients and integrate certificates into their server environments, which demands a certain level of technical expertise. If the setup is not done correctly, it can result in issues such as improper certificate installation or expired certificates, leaving the server vulnerable to security risks. Thus, while these solutions help automate parts of the process, they still require substantial manual effort and expertise, leading to potential inefficiencies and errors.

Our invention offers a solution to many problems found in current SSL/TLS certificate management systems by using AI and automation to streamline the entire process. Existing solutions, such as SSL/TLS Certificate Authorities (CAs), automate parts of certificate issuance, but they still require significant manual intervention for tasks like installation, configuration, renewals, and security updates. This creates complexity and increases the risk of human error, such as forgetting to renew certificates or failing to apply security updates on time.

Our platform solves these problems by automating every step of the SSL/TLS certificate lifecycle, including issuance, installation, renewal, and management. By leveraging AI-assisted automation, the system reduces manual effort while ensuring that these tasks are performed correctly and on time.

Moreover, our platform is designed to be user-friendly and does not require technical expertise, making it accessible to non-technical users. This reduces barriers for small businesses or individuals who may struggle with complex certificate management tools. Overall, our invention simplifies SSL/TLS certificate management, enhances security, and significantly reduces the risk of errors.

Existing technologies lacked sufficient automation, which led to increased complexity in managing the SSL/TLS certificate lifecycle. Our invention automates the entire process, thereby reducing complexity and improving efficiency. This makes our invention a more effective and reliable solution.

### SUMMARY

According to first aspect of the presence invention, a system for automation of SSL certificate lifecycle generation, to eliminate manual processes, fragmentation, insufficient automation, human error, accessibility issues, lack of proactive security, limited customization, the system comprises a user device, associated with a user, configured to provide data as an input; a memory for storage; a processor in communication with the memory, configured to: guide the user using AI for filing the CSR in details; detect an error in the user's data (by comparing the input with a set of predetermined data) using AI; correct the user by checking the user's input; submit the generated one or more CSR based on the correct data received from the user, wherein the platform's AI reviews and optimizes the CSR for security before submission; issuance of the SSL certificate from the CA upon validation of the CSR; provide multi-cloud and hybrid infrastructure integration using AI: detect a user's server environment using AI; provide optimized SSL configurations using AI; perform secure installation of SSL certificate on the detected server environment using AI; provide penetration testing to identify security vulnerabilities in the SSL configuration and overall security using AI: perform a penetration test using AI; identify vulnerabilities using AI; generate an automated report detailing the vulnerabilities; provide AI-assisted remediation steps for the user to apply to their SSL certificates and server configuration; proactive monitoring to continuously monitor the certificate status and security performance using AI: monitor the status of SSL certificates issued to user and vulnerabilities periodically; initiate the renewal or update based on the detected threat using AI; update a user's SSL certificate and server configuration based on the detected threat using AI; provide on-demand key rotation based on detected threat by changing cryptographic keys using AI: monitor vulnerabilities or threat periodically; identify vulnerabilities or threat; generate a new cryptographic key using AI; update the cryptographic key without causing downtime; Management of SSL certificate using AI: monitor the status and security of SSL certificate through proactive monitoring using AI, performing checks periodically; detect expiration date and vulnerabilities of SSL certificate using AI; trigger the renewal or update process to maintain security and avoid downtime using AI; manage user's SSL certificate across multiple platform and server environment; provide a unified dashboard to manage SSL certificate across multiple platform and server environment, thereby eliminating manual processes, fragmentation, insufficient automation, human error, accessibility issues, lack of proactive security, limited customization.

In accordance with an embodiment of the present invention, the data comprising organization name, domain name, public key, organizational unit, country name and state.

In accordance with an embodiment of the present invention, the error comprising error in organization name, domain name, common name, organizational unit, country name and state.

In accordance with an embodiment of the present invention, the validation of data include validation of organization name, domain name, public key, organizational unit, country name, state or CSR details.

In accordance with an embodiment of the present invention, the user includes individuals, companies, firms, businesses.

In accordance with an embodiment of the present invention, the SSL certificate includes a public key.

In accordance with an embodiment of the present invention, the CA is a certificate authority.

In accordance with an embodiment of the present invention, the user's server environment includes cloud platform (AWS, Google cloud, Azure) and on premise server.

In accordance with an embodiment of the present invention, the optimized SSL configuration includes configuring an SSL certificate according to user's server environment.

In accordance with an embodiment of the present invention, the automated report includes details of vulnerabilities detected in scan, SSL certificate status, web server and hosting information, actionable insights. Wherein vulnerabilities may include self-signed certificates, DNS enumeration (subdomains, DNS records), port scanning (to find open services), web app & SSL scanning (non-intrusive vulnerability detection), email server testing (SPF, DMARC), reconnaissance (headers, certificate analysis), and web server and hosting information includes server type and version, hosting provider, and actionable insights includes risk severity ratings, detailed impact analysis of vulnerabilities, recommended priority for remediation.

In accordance with an embodiment of the present invention, wherein the AI-assisted remediation steps may include upgrade to a secure protocol (TLS 1.2 or TLS 1.3), Renew certificates, install intermediate certificates, secure hardening recommendations, authentication and authorization enhancements, monitoring and incident response setup, security hardening recommendations

In accordance with an embodiment of the present invention, the threat include unauthorized access, cyber-attacks, web server vulnerabilities, wherein unauthorized access may include misconfigured SSL certificates, publicly accessible administration interfaces, cyber-attacks may include MITM attacks, phishing domain detection, DoS vulnerability detection, data interception via insecure protocols, and web server vulnerabilities may include outdated web server configuration, exposed API Endpoints.

In accordance with an embodiment of the present invention, proactive monitoring include real time threat detection process, and renewal of SSL certificate.

In accordance with an embodiment of the present invention, the real-time threat detection process includes continuously monitoring the SSL certificate to detect threats in real-time.

In accordance with an embodiment of the present invention, the renewal of SSL certificates includes continuously monitoring the expiration of SSL certificate and trigger automatic renewal of SSL certificate by using AI.

In accordance with an embodiment of the present invention, the cryptographic key includes public key and private key.

In accordance with an embodiment of the present invention, the key rotation may be performed as user-initiated rotation, policy-based rotation, and seamless transition.

In accordance with an embodiment of the present invention, the management of SSL certificate includes management of configuration of SSL certificate.

In accordance with an embodiment of the present invention, the configuration of SSL certificate includes renewal, update, security threat detection and expiry of SSL certificate.

According to second aspect of the presence invention, a method for automation of SSL certificate lifecycle generation, to eliminate manual processes, fragmentation, insufficient automation, human error, accessibility issues, lack of proactive security, limited customization, the method comprises providing data as an input; guiding the user using AI for filing the CSR in details; detecting an error in the user's data (by comparing the input with a set of predetermined data) using AI; correcting the user by checking the user's input; submitting the generated one or more CSR based on the correct data received from the user, wherein the platform's AI reviews and optimizes the CSR for security before submission; issuing of the SSL certificate from the CA upon validation of the CSR; detecting a user's server environment using AI; providing optimized SSL configurations using AI; performing secure installation of SSL certificate on the detected server environment using AI; performing a penetration testing using AI; identifying vulnerabilities using AI; generating an automated report detailing the vulnerabilities; providing AI-assisted remediation steps for the user to apply to their SSL certificates and server configuration; monitoring the status of SSL certificates issued to user and vulnerabilities periodically; initiating the renewal or update based on the detected threat using AI; updating a user's SSL certificate and server configuration based on the detected threat using AI; monitoring vulnerabilities or threat periodically; identifying vulnerabilities or threat; generating a new cryptographic key using AI; updating the cryptographic key without causing downtime; monitoring the status and security of SSL certificate through proactive monitoring using AI, performing checks periodically; detecting expiration date and vulnerabilities of SSL certificate using AI; triggering the renewal or update process to maintain security and avoid downtime using AI; managing user's SSL certificate across multiple platform and server environment; providing a unified dashboard to manage SSL certificate across multiple platform and server environment, thereby eliminating manual processes, fragmentation, insufficient automation, human error, accessibility issues, lack of proactive security, limited customization.

In accordance with an embodiment of the present invention, the data comprises organization name, domain name, public key, organizational unit, country name and state.

In accordance with an embodiment of the present invention, the error comprising error in organization name, domain name, common name, organizational unit, country name and state.

In accordance with an embodiment of the present invention, the validation of data include validation of organization name, domain name, public key, organizational unit, country name, state or CSR details.

In accordance with an embodiment of the present invention, the user includes individuals, companies, firms, businesses.

In accordance with an embodiment of the present invention, the SSL certificate includes a public key.

In accordance with an embodiment of the present invention, the optimized SSL configuration includes configuring an SSL certificate according to user's server environment.

In accordance with an embodiment of the present invention, the automated report includes details of vulnerabilities detected in scan SSL certificate status, web server and hosting information, actionable insights vulnerabilities includes self-signed certificates, DNS enumeration (subdomains, DNS records), port scanning (to find open services), web app & SSL scanning (non-intrusive vulnerability detection), email server testing (SPF, DMARC), reconnaissance (headers, certificate analysis), and web server and hosting information includes server type and version, hosting provider, and wherein actionable insights includes risk severity ratings, detailed impact analysis of vulnerabilities, recommended priority for remediation..

In accordance with an embodiment of the present invention, wherein the AI-assisted remediation steps include upgrade to a secure protocol (TLS 1.2 or TLS 1.3), Renew certificates, install intermediate certificates, secure hardening recommendations, authentication and authorization enhancements, monitoring and incident response setup, security hardening recommendations.

In accordance with an embodiment of the present invention, the threat includes unauthorized access, cyber-attacks web server vulnerabilities, wherein unauthorized access includes misconfigured SSL certificates, publicly accessible administration interfaces, cyber-attacks includes MITM attacks, phishing domain detection, DoS vulnerability detection, data interception via insecure protocols, and web server vulnerabilities includes outdated web server configuration, exposed API Endpoints.

In accordance with an embodiment of the present invention, the proactive monitoring includes real time threat detection process and renewal of SSL certificate.

In accordance with an embodiment of the present invention, the cryptographic key includes public key and private key.

In accordance with an embodiment of the present invention, the key rotation may be performed as user-initiated rotation, policy-based rotation, and seamless transition.

In accordance with an embodiment of the present invention, the management of SSL certificate includes management of configuration of SSL certificate.

In accordance with an embodiment of the present invention, the configuration of SSL certificate includes renewal, update, security threat detection and expiry of SSL certificate.

### BRIEF DESCRIPTION OF THE DRAWINGS

So that the manner in which the above recited features of the present invention can be understood in detail, a more particular description of the invention, briefly summarized above, may have been referred by embodiments, some of which are illustrated in the appended drawings. It is to be noted, however, that the appended drawings illustrate only typical embodiments of this invention and are therefore not to be considered limiting of its scope, for the invention may admit to other equally effective embodiments.

These and other features, benefits, and advantages of the present invention will become apparent by reference to the following text figure, with like reference numbers referring to like structures across the views, wherein

FIG. 1 is an exemplary environment of computing devices to which the various embodiments described herein may be implemented in accordance with the embodiment of the present invention;

FIG. 2 illustrates a system-implemented method for generating an SSL certificate using AI, providing multi-cloud . integration, performing penetration testing using AI, performing proactive monitoring, providing on demand key rotation, performing management of SSL certificate using AI, in accordance with the embodiment of the present invention;

FIG. 3 illustrates an information flow diagram of the user, communication network, processing unit, and memory storage, in accordance with the embodiment of the present invention; and

FIGS. 4 and 5 illustrate an information flow diagram of the user, communication network, processing unit, and memory storage. In this diagram, the processor validates the data by checking user information, optimizes the CSR security before submission, detects the user's server environment, and provides an optimized SSL configuration for secure installation in the user's environment and perform penetration testing using AI, in accordance with the embodiment of the present invention.

### DETAILED DESCRIPTION

The present invention is described hereinafter by various embodiments with reference to the accompanying drawing, wherein reference numerals used in the accompanying drawing correspond to the like elements throughout the description.

While the present invention is described herein by way of example using embodiments and illustrative drawings, those skilled in the art will recognize that the invention is not limited to the embodiments of drawing or drawings described and are not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed, but on the contrary, the invention is to cover all modifications, equivalents, and alternatives falling within the scope of the present invention as defined by the appended claim. As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes.

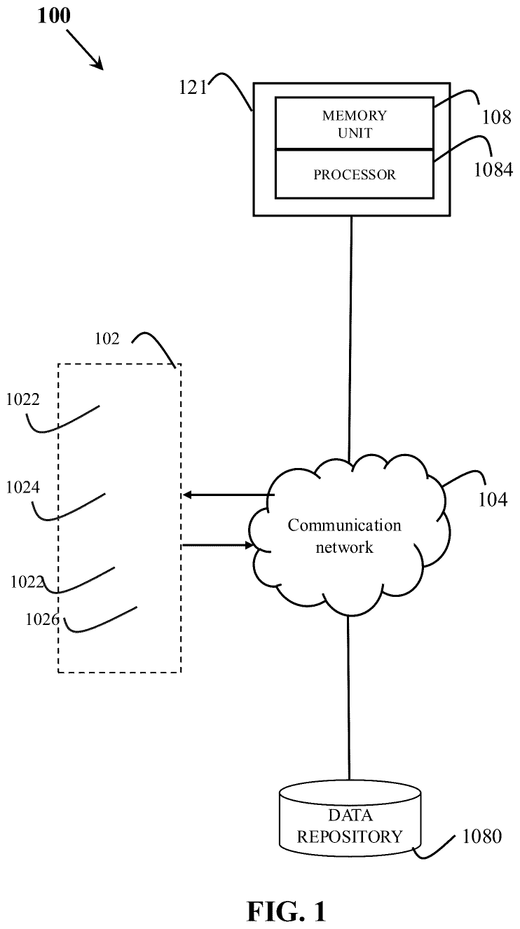

Referring to the drawings, the invention will now be described in more detail. FIG. 1 illustrates an exemplary environment 100 of computing devices to which the various embodiments described herein may be implemented. FIG. 1 shows a first party device 102 connected with a communication network 104.The first party device 121 associated with communication network 104 and communication network 104 is connected with memory storage 1080 and processing unit 121. The memory storage 1080 may be, but not limited to, cloud or on-premise server.

The first party device 102 computing devices selected from a group comprising a laptop, a desktop, and a portable handheld device, all having computing capabilities and comprising at least a processor, a memory unit, a display module, an input module and a user interface. The first party device 102, memory storage device 1080, and processing unit 121 are connected with a communication network 104. The communication network 104 may be one of, but not limited to, a Local Area Network (LAN) or a Wide Area Network (WAN). The communication network 104 may be implemented using a number of protocols, such as but not limited to, TCP/IP, 3GPP, 3GPP2, and LTE.

The processing unit 121 includes computing capabilities such as memory unit 108 configured to store machine readable instructions. The machine-readable instructions may be loaded into the memory unit 108 from a non-transitory machine-readable medium such as, but not limited to, CD-ROMs, DVD-ROMs and Flash Drives. Alternately, the machine-readable instructions may be loaded in a form of a computer software program into the memory unit 108. The memory unit 108 in that manner may be selected from a group comprising EPROM, EEPROM and Flash memory. Further, the processing unit 102 includes a processor 1084 operably connected with the memory unit 108. In various embodiments, the processor 1084 is one of, but not limited to, a general-purpose processor 1084, an application specific integrated circuit (ASIC) and a field-programmable gate array (FPGA).

The processing unit 121 includes computing capabilities such as processor 1084 configured to process data. In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device. Further, while one or more operations have been described as being performed by or otherwise related to certain modules, devices or entities, the operations may be performed by or otherwise related to any module, device or entity. As such, any function or operation that has been described as being performed by a module could alternatively be performed by a different server, by the cloud computing platform, or a combination thereof. It should be understood that the techniques of the present disclosure might be implemented using a variety of technologies. For example, the methods described herein may be implemented by a series of computer executable instructions residing on a suitable computer readable medium. Suitable computer readable media may include volatile (e.g. RAM) and/or non-volatile (e.g. ROM, disk) memory, carrier waves and transmission media. Exemplary carrier waves may take the form of electrical, electromagnetic or optical signals conveying digital data streams 10 along a local network or a publicly accessible network such as the Internet.

The memory storage 1080 is used to store data; memory storage may also be used in the system for storing data and connecting the processing unit 121 with local or remote storage resources. The memory storage can be either cloud-based or located on an on-premise server, depending on the system's requirements. The memory storage may be implemented using various technologies and protocols, such as, but not limited to, file systems, object storage systems, or block storage. The memory storage may be cloud storage selected from different services.

In accordance with an embodiment of the present invention, a communication network 104 may also be used in the system for connecting the components within the system or connecting the processing unit 121 with a remote analytic system. The communication network 104 can be a short-range communication network and/or a long-range communication network, wire or wireless communication network 104. The communication interface includes, but not limited to, a serial communication interface, a parallel communication interface or a combination thereof. The communication network 104 may be implemented using a number of protocols, such as but not limited to, TCP/IP, 3GPP, 3GPP2, LTE, IEEE 802.x etc. The communication network 104 may be wireless communication network selected from one of, but not limited to, Bluetooth, radio frequency, internet or satellite communication network providing maximum coverage.

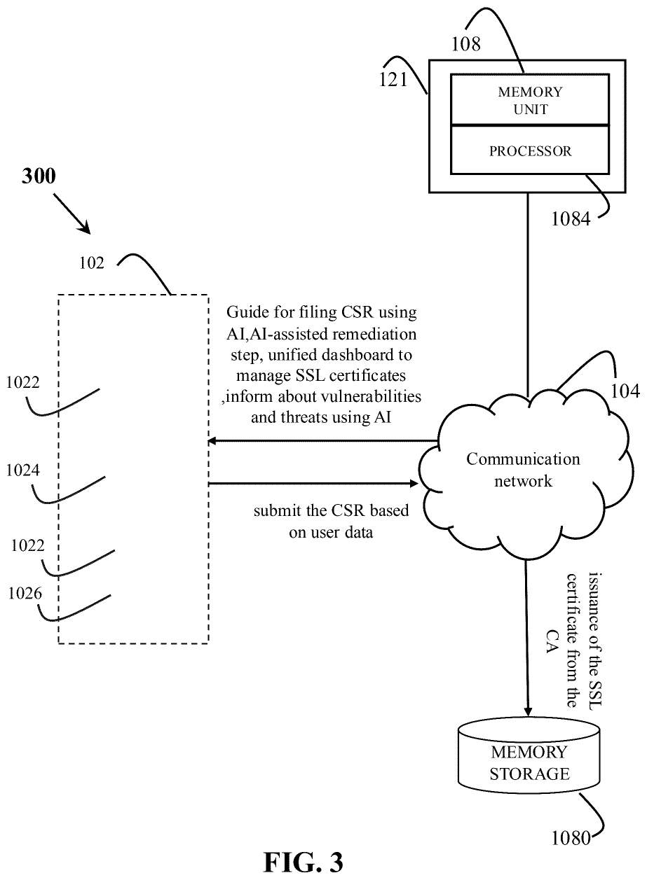

FIG. 3 illustrate the interaction between the components, where the first-party device 102 sends a CSR to the Certification Authority via the communication network. After validation, the CA verifies the CSR and issues an SSL certificate, which is then stored in the memory storage.

Subsequently, the processing unit 121 guides the first-party device through the process of filing the CSR using AI. It provides AI-assisted remediation steps, a unified dashboard for managing SSL certificates, and informs the first-party device about vulnerabilities and threats related to the SSL certificate. FIG. 3 illustrates this entire process, highlighting the seamless interaction and flow of data between the first-party device, the CA, and the processing unit.

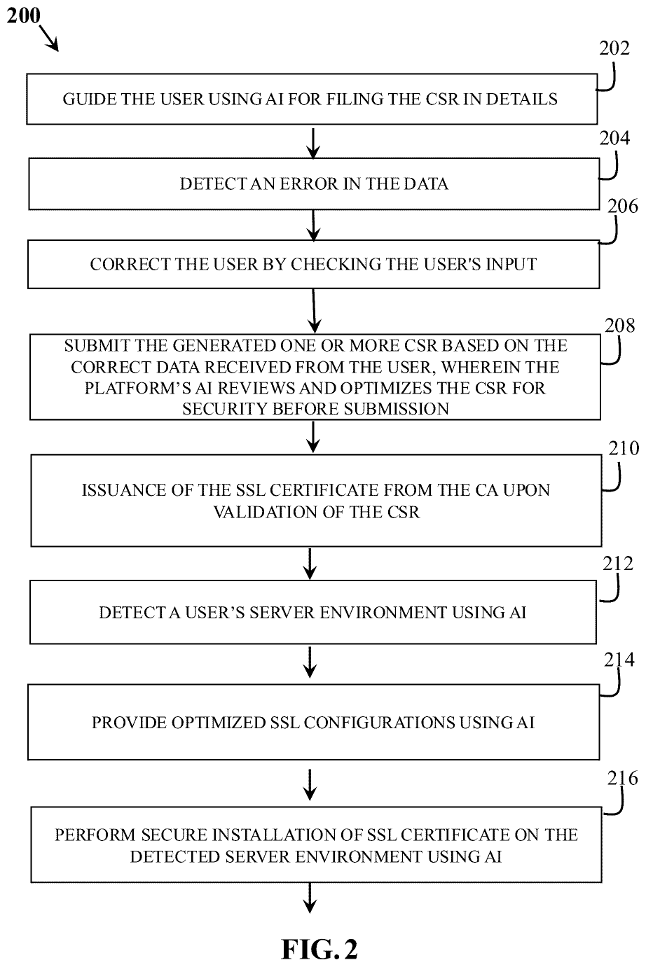

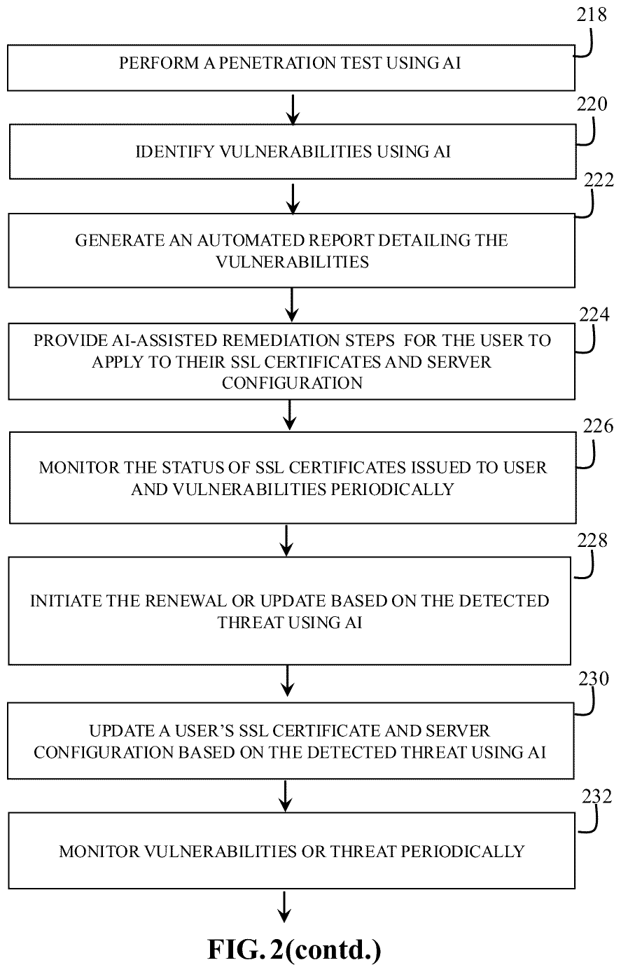

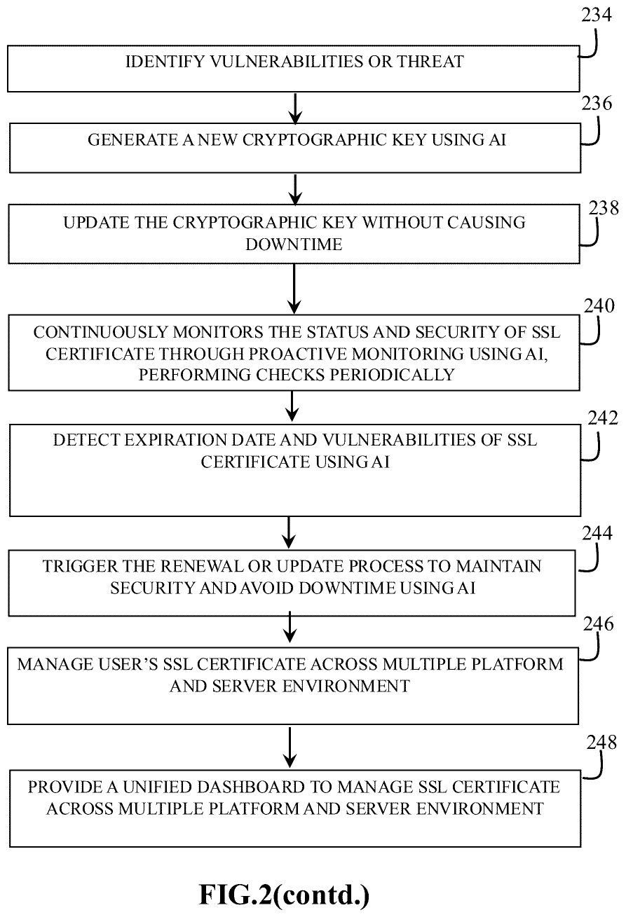

FIG. 2 illustrates implemented method for generating AI-based SSL certificate and its management, providing AI-assisted multi-cloud and hybrid infrastructure integration, performing penetration testing using AI, performing proactive monitoring using AI, performing on-demand key rotation using AI, in accordance with an embodiment of the present invention. The method begins at step 202, first the AI will guide the user to fill the CSR in detail. The AI helps the user to fill in the required fields, such as Common Name (CN), organization, location, email address, domain name, etc. It can also provide automatic suggestions to help ensure that the user's input is correct and properly formatted. This reduces the chances of errors and makes the process easier for the user.

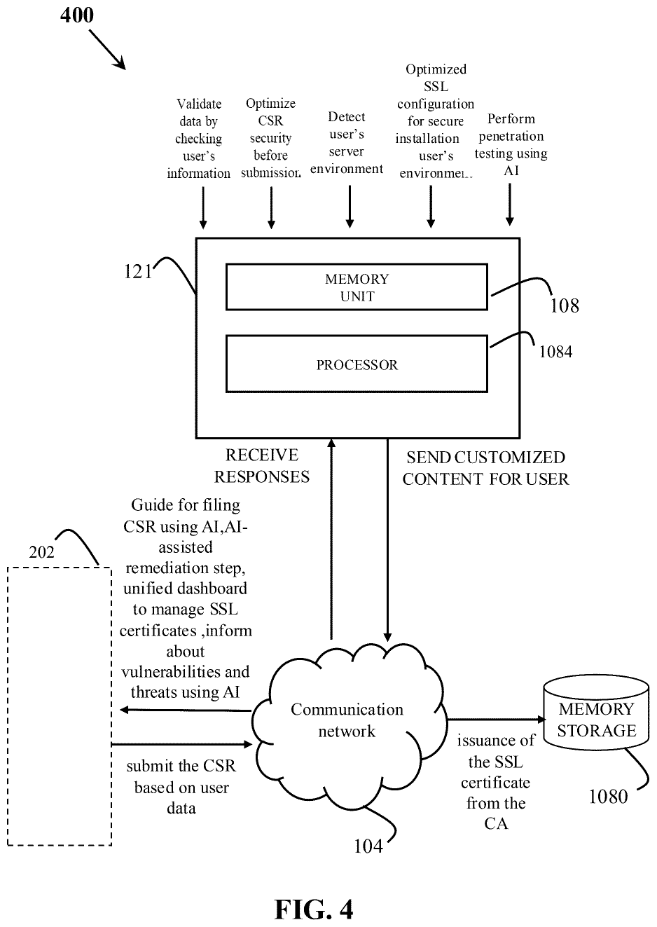

Then at step 204, AI detects errors in the data provided by the user during the CSR (Certificate Signing Request) creation process for SSL certificate generation. The AI performs several checks to ensure that the data entered is accurate and meets the required standards. Firstly, AI validates the format of critical information, such as domain names, email addresses, and organization details. For instance, it verifies that the domain name is valid, email addresses follow the proper format and all other fields are entered correctly. Additionally, the AI checks the Common Name field to ensure that the domain name for which the SSL certificate is requested matches the domain being used and adheres to valid domain rules. The AI also performs a field completeness check, identifying missing or incomplete fields, such as missing organization names or country information, and prompts the user to fill in the necessary details. It ensures cross-field consistency by comparing values entered in multiple fields, such as ensuring the organization name matches across the Organization and Organizational Unit fields. Furthermore, AI can validate the domain name by checking if it is registered or exists via DNS lookup. The system also includes error prediction and suggestions, identifying common user mistakes like special characters in the domain name or misspelled. Additionally, it offers suggestions and prompts for error-free submissions, making the process accessible to non-technical users. (also shown in FIG. 4).

Then at step 206, when AI detects any errors during the process of filling out the CSR, or after the user has completed it, it will automatically flag the issue. The AI will then guide the user in correcting the mistake by providing clear instructions or suggestions to rectify the error. This real-time feedback ensures that the user's input is an accurate, thus preventing common mistake, such as incorrect formatting, missing information, or invalid values. By doing so, the AI helps maintain the integrity of the CSR, ensuring that all required fields are properly filled. Ultimately, this leads to the successful and accurate generation of the SSL certificate, reducing the chances of errors that could delay or prevent the issuance of the certificate.

Then at step 208, once the user has provided the necessary details to fill out the Certificate Signing Request (CSR), the platform's AI reviews the data to ensure its accuracy and security. The AI carefully examines the CSR to verify that all required fields are correctly filled and that the data adheres to proper formatting and security standards. This process includes checking for any missing or incorrectly entered information, such as domain names, organization details, or encryption algorithms.

Before submitting the CSR for SSL certificate generation, the AI also performs security checks to optimize the request. This includes assessing the strength of encryption methods used, ensuring that the CSR complies with industry standards and validating that no security vulnerabilities are present in the CSR. If the AI detects any issues, it will notify the user and suggest corrective actions. Only after the AI confirms the CSR meets all necessary security and formatting requirements will the CSR be submitted to the appropriate Certificate Authority for SSL certificate issuance (also shown in FIG. 4). This process prevents delays caused by submission errors.

Then at step 210, upon successful validation of the Certificate Signing Request by the platform's AI, the validated CSR is submitted to the Certificate Authority for the issuance of the SSL certificate. The CA performs additional checks to verify the authenticity of the CSR, including the identity of the requester and validating the details contained within the CSR against public domain records, such as DNS records, organizational identity, and domain ownership. Once the CSR is validated by the CA, the CA issues an SSL certificate, which is then transmitted back to the platform. The issued SSL certificate contains public key, cryptographic information, and the associated domain name, ensuring that communication between the user's server and clients is secure and encrypted.

Then at step 212, after the SSL certificate is generated, the platform's AI automatically detects the user's server environment to configure the SSL certificate. The AI evaluates the server's environment, including its operating system, web server software, and relevant configurations, to determine the best way to integrate the SSL certificate to ensure proper installation and functionality without requiring manual intervention from the user (also shown in FIG. 4).

Then at step 214, after detecting user's server environment the platform's AI automatically provides optimized SSL configurations. The AI evaluates the server's security requirements and environment settings to determine the most suitable configurations for the SSL certificate, ensuring both maximum security and optimal performance. These configurations are applied automatically, eliminating the need for manual adjustments by the user. Once the configurations are optimized, the AI stores the configuration settings and related data either in the cloud or on an on-premise server, depending on the user's preferences and infrastructure setup (also shown in FIG. 4). This minimizes manual setup efforts and ensures the SSL configurations are fully compatible with the user's server environment.

Then at step 216, the platform's AI securely installs the SSL certificate in the detected server environment. Once the server environment is identified and the certificate configurations are optimized. This process ensures that the server's security protocols are properly applied, providing encrypted communication between the user's server and clients.

Then at step 218, after the SSL certificate is installed, the platform's AI performs a penetration test to evaluate the server's security. This automated test helps identify any security gaps and verifies the strength of the server's encryption, providing an additional layer of protection without requiring manual intervention For example, the AI scans for vulnerabilities such as outdated software, weak encryption methods, or open ports. It then simulates real-world attack scenarios to check if these vulnerabilities can be exploited. If any weaknesses are found, the AI generates a report with recommendations for enhancing security. (also shown in FIG. 4).

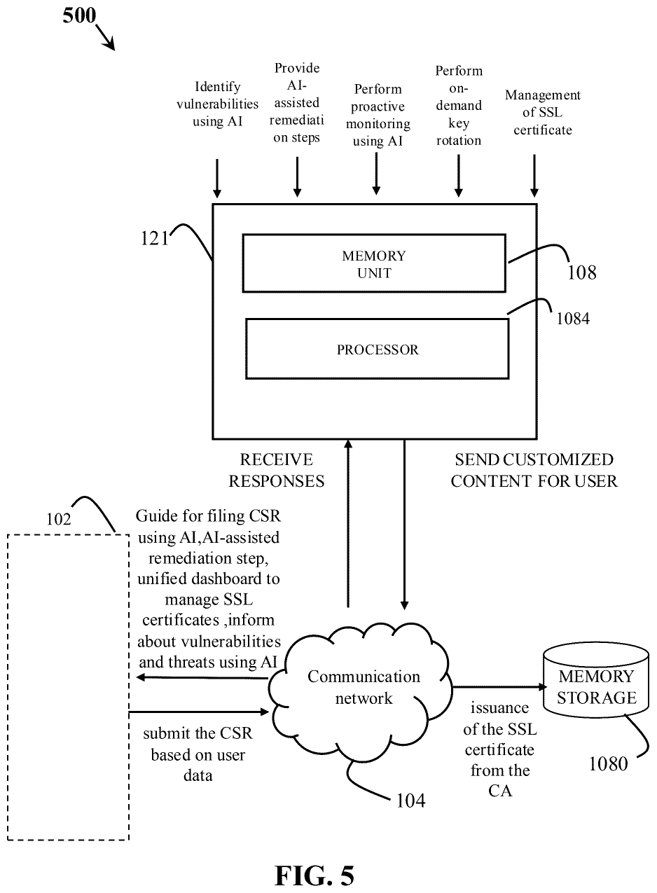

Then at step 220, after penetration testing, the AI identifies vulnerabilities using advanced algorithms by AI. These vulnerabilities could include expired or invalid SSL certificates, self-signed certificates, and missing or weak encryption protocols (e.g., TLS 1.0, 1.1). The system also identifies the use of insecure cipher suites and the lack of HTTP Strict Transport Security (HSTS) headers, which could compromise secure communications. When it comes to domain-level vulnerabilities, the system checks for DNS misconfigurations, such as missing CAA (Certificate Authority Authorization) records, which can lead to unauthorized certificate issuance. It also flags publicly accessible subdomains or sensitive endpoints that lack SSL encryption, ensuring that all sensitive data transmissions are secured. Additionally, the system scans for web server misconfigurations, such as outdated web server software (e.g., Apache or Nginx), exposed server information through HTTP headers, and missing redirection from HTTP to HTTPS, which can leave a server vulnerable to attacks. The system performs threat modeling, identifying risks associated with unencrypted communications or exposed endpoints, which could lead to unauthorized access or cyber-attacks like man-in-the-middle attacks. Lastly, it assesses third-party dependency issues, detecting vulnerable third-party components or libraries used by the web server through metadata analysis, ensuring that all components meet security standards. (also shown in FIG. 5) For example, the AI might detect outdated software versions, weak encryption protocols, or open ports by scanning the system's configurations and cross-referencing them with known vulnerabilities. It may also identify weak passwords by testing for common patterns or by attempting brute-force attacks, revealing potential entry points for attackers.

Then at step 222, after identifying the vulnerabilities, the platform's AI generates an automated report detailing each of the identified security issues. This report includes SSL Certificate Status section provides the expiration date, issuer information, and certificate type (e.g., DV, OV, EV). Additionally, it includes the validity period and an analysis of the chain of trust. The Vulnerabilities Detected section highlights any missing or incorrect SSL configurations (e.g., incomplete chain, weak ciphers), as well as expired or self-signed certificates. It also identifies protocol vulnerabilities (e.g., TLS version downgrade attacks, weak TLS versions such as TLS 1.0/1.1), and host misconfigurations such as open ports or exposed services. The Web Server and Hosting Information section provides details about the server type and version (e.g., Apache 2.4, Nginx 1.21) and the hosting provider (e.g., AWS, GoDaddy, DigitalOcean). Finally, the Actionable Insights section includes risk severity ratings (low, medium, high), a detailed impact analysis of vulnerabilities, and the recommended priority for remediation.. The automated report is designed to be easily understandable and actionable, enabling system administrators or security professionals to take immediate steps to mitigate the risks.

Then at step 224, after generating the automated report, the platform's AI provides AI-assisted remediation steps for the user to apply to their SSL certificates and server configuration. These remediation steps are tailored to address the identified vulnerabilities and enhance the overall security of the server. The AI analyzes the specific issues found in the report and suggests actionable solutions, such as updating configurations, applying patches, or modifying security settings. This process allows users to improve their server security with minimal manual effort, ensuring that their SSL certificates and server environment remain secure and up to date (also shown in FIG. 5). Remediation steps include: SSL installation and renewal guidance, security hardening recommendations, authentication and authorization enhancements, monitoring and incident response setup These steps begin with SSL Installation and Renewal Guidance, which provides commands for certificate installation, such as Certbot or OpenSSL, tailored specifically for the user's server. Additionally, the system includes automatic renewal configuration instructions and a detailed walkthrough for enabling HTTPS across services to ensure secure communication. The second step focuses on Security Hardening Recommendations, which include instructions to disable weak cipher suites and enforce strong encryption protocols, as well as directions for implementing HTTP Strict Transport Security (HSTS). It also provides guidelines for configuring firewall rules and securing server ports to safeguard the infrastructure. The next set of enhancements is related to Authentication and Authorization, where the system recommends implementing multi-factor authentication (MFA) to strengthen access control. It also offers secure management practices for API keys and access tokens and suggests best practices for ensuring least privilege access control. Finally, the system outlines Monitoring and Incident Response Setup, which provides guidance for setting up intrusion detection systems (IDS) and instructions for log monitoring and anomaly detection. It also includes steps for configuring automated threat notifications to ensure timely responses to potential security incidents.

Then at step 226, the platform's AI continuously performs real-time monitoring of the SSL certificates issued to the user, ensuring that they remain valid, secure, and properly configured. This monitoring also includes periodic checks for potential vulnerabilities, such as expired certificates, weak encryption protocols, or emerging security threats. In addition to detecting vulnerabilities, the AI automatically tracks certificate expiration dates and handles the renewal process, ensuring that certificates are always up to date. The AI also monitors any changes to the server environment that could affect the SSL certificate's performance. This real-time, automated monitoring and renewal process ensures the on-going security and integrity of the SSL certificates without requiring manual intervention, keeping the user's server environment secure at all times.

Then at step 228, after performing continuous monitoring of the SSL certificates, the platform's AI initiates the renewal or update process based on the detected threats or vulnerabilities. If the AI detects any potential security risks, such as an expired certificate, weak encryption, or a new vulnerability, it automatically triggers the renewal or update of the SSL certificate to mitigate these threats.

Then at step 230, after the SSL certificate is renewed, if the platform's AI detects any additional threats or vulnerabilities, it automatically takes steps to update the user's SSL certificate and server configuration to address the new risks. The AI continuously monitors the server environment for any emerging security issues, such as weak encryption, out-dated protocols, or new vulnerabilities. Upon detecting a new threat, the AI analyzes its impact and determines the best course of action to mitigate it. This may involve updating the SSL certificate with stronger encryption, adjusting server configurations, or applying security patches. The AI ensures that these updates are applied seamlessly, without requiring manual intervention from the user.

Then at step 232, the platform's AI again periodically monitors vulnerabilities and threats to ensure the SSL certificates and server configurations remain secure For example, vulnerabilities may include DNS enumeration (subdomains, DNS records), port scanning (to find open services), web app & SSL scanning (non-intrusive vulnerability detection), email server testing (SPF, DMARC), and reconnaissance (headers, certificate analysis) and threats may include unauthorized access threats and cyber-attacks, providing proactive measures to mitigate these risks. Misconfigured SSL certificates are detected, such as expired or self-signed certificates, which could allow attackers to intercept communication via man-in-the-middle (MITM) attacks. The system also detects the absence of HTTP Strict Transport Security (HSTS), allowing the AI to recommend secure configurations remotely to prevent unauthorized access over unencrypted channels. Additionally, the system identifies publicly accessible administration interfaces, flagging exposed admin panels that lack SSL protection to mitigate unauthorized login attempts and secure these interfaces. In terms of cyber-attacks, the system detects man-in-the-middle (MITM) attacks by identifying weak SSL/TLS configurations or the absence of encryption, preventing potential eavesdropping by recommending the necessary steps to secure the communication channel. The system also performs phishing domain detection by analyzing domain configurations and subdomains to identify potential spoofed domains or typo-squatting, helping prevent phishing campaigns aimed at tricking users into accessing malicious sites. Denial-of-service (DoS) vulnerability detection is another key function, where the system identifies unsecured, publicly available services that could be exploited in DoS attacks. It suggests best practices for closing unnecessary ports and enforcing rate-limiting mechanisms to mitigate these risks. Additionally, the AI scans for data interception via insecure protocols, identifying outdated protocols like TLS 1.0/1.1 or insecure cipher suites and providing recommendations for upgrading to secure versions to mitigate potential data breaches. In terms of web server vulnerabilities, the system detects outdated web server configurations such as those in Apache or Nginx from public headers, which could be exploited in cyber-attacks. AI recommends appropriate security patches or configuration updates to address these vulnerabilities. Furthermore, the system identifies exposed API endpoints, flagging unsecured endpoints that lack SSL protection, and mitigates unauthorized access or data leakage by recommending secure authentication and encryption methods.

Then at step 234, after monitoring, the platform's AI identifies vulnerabilities or threats that require a change in the cryptographic key such as compromised keys or out-dated encryption methods. The AI also identifies threats, which may include unauthorized access, cyber-attacks, and web server vulnerabilities. Unauthorized access could result from misconfigured SSL certificates or publicly accessible administration interfaces. Cyber-attacks may include Man-In-The-Middle (MITM) attacks, phishing domain detection, DoS vulnerability detection, or data interception via insecure protocols. Web server vulnerabilities may involve outdated web server configurations or exposed API endpoints.

Then at step 236, after identifying the need for a key change, the platform's AI generates new cryptographic keys to replace the compromised or out-dated ones. These newly generated keys ensure stronger encryption and improved security for the SSL certificate, helping to protect the server's communication and prevent potential security breaches (also shown in FIG. 5).

Then at step 238, the key rotation process is handled by the AI in stages to ensure no downtime. The AI performs the update in the background, making necessary changes without disrupting on-going sessions. Existing sessions continue with the old keys until the update is complete, after which new sessions will be secured using the updated keys. This seamless key rotation ensures continuous security and uninterrupted service, allowing the server to remain operational throughout the process (also shown in FIG. 5).

Then at step 240, the platform's AI continuously monitors the status and security of the SSL certificate through proactive monitoring. It performs periodic checks to ensure the certificate remains valid, secure, and properly configured. This includes detecting vulnerabilities, expired certificates, weak encryption, or emerging threats, allowing the system to take timely action to maintain security and to manage entire certificate (also shown in FIG. 5).

Then at step 242, the platform's AI detects the expiration date and vulnerabilities of the SSL certificate by continuously monitoring it. It checks for issues like expired certificates, weak encryption, and security threats, ensuring timely identification and action to maintain certificate validity and security.

Then at step 244, the platform's AI triggers the renewal or update process of the SSL certificate to maintain security and avoid downtime. It automatically initiates the necessary actions when expiration or vulnerabilities are detected, ensuring continuous protection without manual intervention and the system allows for configuration changes by implementing AI-recommended changes in essential server configuration files, such as nginx.conf and .htaccess. These changes are designed to enhance server security, optimize performance.

Then at step 246, the platform's AI manages the user's SSL certificate across multiple platforms and server environments. It ensures that the SSL certificate is correctly configured, secure, and up-to-date on all systems, streamlining management without manual intervention.

Then at step 248, the platform provides a unified dashboard that allows users to manage their SSL certificates across multiple platforms and server environments from a single interface. This dashboard consolidates all relevant SSL certificate information, including status, expiration dates, security settings, and configurations, in one place. Users can easily view and manage certificates for different servers or platforms without having to navigate through multiple systems. The unified dashboard simplifies the process of monitoring and updating SSL certificates, ensuring that they remain secure and up-to-date. Users can initiate renewals, apply security patches, or make necessary configuration changes directly through the dashboard. It also helps to identify any potential issues or vulnerabilities, allowing users to take timely action to maintain the security.

In accordance with an embodiment, the platform supports both User-Initiated and Policy-Based Rotations of cryptographic keys. Users can request key rotations at any time via the platform, and the AI automatically generates new keys and updates SSL certificates. Additionally, the platform allows users to set security policies to trigger automatic key rotations based on specific conditions, such as breach detection or compliance requirements. The rotation process ensures a seamless transition, with no downtime or disruption to secure connections.

In accordance with an embodiment, the platform allows for both public and private key rotations. Users can request changes to either key individually or both simultaneously. When changing the private key, the platform ensures that the corresponding public key is updated accordingly to maintain the integrity of the SSL certificate. The AI manages the entire process, ensuring seamless transitions without causing downtime or disrupting secure connections.

In accordance with an embodiment, the platform enables both real-time monitoring and renewal processes to be included under proactive monitoring, Users can monitor and renew certificates in real-time, while the platform ensures that these actions are seamlessly integrated within proactive monitoring framework. The AI manages the entire process, ensuring continuous security and optimal performance without any disruption. The present invention have following technical advantage:

Unlike existing solutions like ACME, which primarily automate the renewal process, our invention leverages Generative AI to manage the full lifecycle of SSL certificate from issuance and installation to ongoing proactive monitoring and for entire management of SSL certificates.

A key technical advantage of our invention is its ability to integrate all aspects of SSL certificate management into a single, unified platform, where AI handles every step of the process.

A key technical advantage of our invention is its ability to perform AI-driven penetration testing, enabling the system to simulate potential security breaches and proactively identify vulnerabilities. By leveraging AI, the system conducts thorough, automated security assessments, detects weak points, and recommends remediation actions in real time, ensuring the highest level of security for SSL certificates and the entire infrastructure.

A key technical advantage of our system is its ability to automatically perform cryptographic key changes using AI-driven automation.

A key technical advantage of our invention is its ability to perform real-time monitoring using AI, enabling the system to detect and identify potential threats instantly.

A key advantage of our invention is its unified dashboard, which makes SSL management easier across platforms. AI guidance also reduces the need for technical expertise, making it more user-friendly.

A key advantage of our invention is supporting multi platform integration, including AWS, Google Cloud, and Azure, allowing for streamlined operation and increased flexibility. This enables our solution to be easily integrated into a wide range of environments.

It should be noted that where the terms “server”, “secure server” or similar terms are used herein, a communication device is described that may be used in a communication system, unless the context otherwise requires, and should not be construed to limit the present disclosure to any particular communication device type. Thus, a communication device may include, without limitation, a bridge, router, bridge-router (router), switch, node, or other communication device, which may or may not be secure.

Further, the operations need not be performed in the disclosed order, although in some examples, an order may be preferred. Also, not all functions need to be performed to achieve the desired advantages of the disclosed system and method, and therefore not all functions are required.

The terms and descriptions used herein are set forth by way of illustration only and are not meant as limitations. Examples and limitations disclosed herein are intended to be not limiting in any manner, and modifications may be made without departing from the spirit of the present disclosure. Those skilled in the art will recognize that many variations are possible within the spirit and scope of the disclosure, and their equivalents, in which all terms are to be understood in their broadest possible sense unless otherwise indicated.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be providing broadest scope of consistent with the principles and the novel and inventive features disclosed or suggested herein. Accordingly, the invention is anticipated to hold on to all other such alternatives, modifications, and variations that fall within the scope of the present invention and appended claims.

1. A system for automation of SSL certificate lifecycle generation, to eliminate manual processes, fragmentation, insufficient automation, human error, accessibility issues, lack of proactive security, limited customization, the system comprising:
a memory unit configured to store machine-readable instructions; and
a processor operably connected with the memory unit, the processor obtaining the machine-readable instructions from the memory unit, and being configured by the machine-readable instructions to:
guide the user using AI for filing the CSR in details;
detect an error in the user's data using AI;
correct the user by checking the user's input;
submit the generated one or more CSR based on the correct data received from the user, wherein the platform's AI reviews and optimizes the CSR for security before submission;
issuance of the SSL certificate from the CA upon validation of the CSR;
provide multi-cloud and hybrid infrastructure integration using AI:
detect a user's server environment using AI;
provide optimized SSL configurations using AI;
perform secure installation of SSL certificate on the detected server environment using AI;
provide penetration testing to identify security vulnerabilities in the SSL configuration and overall security using AI:
perform a penetration test using AI;
identify vulnerabilities using AI;
generate an automated report detailing the vulnerabilities;
provide AI-assisted remediation steps for the user to apply to their SSL certificates and server configuration;
proactive monitoring to continuously monitor the certificate status and security performance using AI:
monitor the status of SSL certificates issued to user and vulnerabilities periodically;
initiate the renewal or update based on the detected threat using AI;
update a user's SSL certificate and server configuration based on the detected threat using AI;
provide on-demand key rotation based on detected threat by changing cryptographic keys using AI;
monitor vulnerabilities or threat periodically;
identify vulnerabilities or threat;
generate a new cryptographic key using AI;
update the cryptographic key without causing downtime;
manage SSL certificate using AI:
monitor the status and security of SSL certificate through proactive monitoring using AI, performing checks periodically;
detect expiration date and vulnerabilities of SSL certificate using AI;
trigger the renewal or update process to maintain security and avoid downtime using AI;
manage user's SSL certificate across multiple platform and server environment; and
provide a unified dashboard to manage SSL certificate across multiple platform and server environment, thereby eliminating manual processes, fragmentation, insufficient automation, human error, accessibility issues, lack of proactive security, limited customization.

2. The system as claimed in claim 1, wherein the data comprising organization name, domain name, public key, organizational unit, country name, state.

3. The system as claimed in claim 1, wherein the error comprising error in organization name, domain name, common name, organizational unit, country name, state.

4. The system as claimed in claim 1, wherein the validation of data include validation of organization name, domain name, public key, organizational unit, country name, state or CSR details.

5. The system as claimed in claim 1, wherein the user includes individuals, companies, firms, businesses.

6. The system as claimed in claim 1, wherein the SSL certificate includes a public key.

7. The system as claimed in claim 1, wherein the CA is a certificate authority.

8. The system as claimed in claim 1, wherein the user's server environment includes cloud platform (AWS, Google cloud, Azure) and on premise server.

9. The system as claimed in claim 1, wherein the optimized SSL configuration includes configuring an SSL certificate according to user's server environment.

10. The system as claimed in claim 1, wherein the automated report includes details of vulnerabilities detected in scan, SSL certificate status, web server and hosting information, actionable insights, wherein vulnerabilities includes self-signed certificates, DNS enumeration (subdomains, DNS records), port scanning (to find open services), web app & SSL scanning (non-intrusive vulnerability detection), email server testing (SPF, DMARC), reconnaissance (headers, certificate analysis), and web server and hosting information includes server type and version, hosting provider, and actionable insights includes risk severity ratings, detailed impact analysis of vulnerabilities, recommended priority for remediation.

11. The system as claimed in claim 1, wherein the AI-assisted remediation steps includes upgrade to a secure protocol (TLS 1.2 or TLS 1.3), Renew certificates, install intermediate certificates, secure hardening recommendations, authentication and authorization enhancements, monitoring and incident response setup, security hardening recommendations.

12. The system as claimed in claim 1, wherein the threat include unauthorized access, cyber-attacks, web server vulnerabilities, wherein unauthorized access may include misconfigured SSL certificates, publicly accessible administration interfaces, cyber-attacks may include MITM attacks, phishing domain detection, DoS vulnerability detection, data interception via insecure protocols, and web server vulnerabilities may include outdated web server configuration, exposed API Endpoints.

13. The system as claimed in claim 1, wherein proactive monitoring include real time threat detection process and renewal of SSL certificate.

14. The system as claimed in claim 1, wherein the real-time threat detection process includes continuously monitoring the SSL certificate to detect threats in real-time.

15. The system as claimed in claim 1, wherein the renewal of SSL certificates includes continuously monitoring the expiration of SSL certificate and trigger automatic renewal of SSL certificate by using AI.

16. The system as claimed in claim 1, wherein the cryptographic key includes public key and private key.

17. The system as claimed in claim 1, wherein the key rotation may be performed as user-initiated rotation, policy-based rotation, seamless transition.

18. The system as claimed in claim 1, wherein the management of SSL certificate include management of configuration of SSL certificate.

19. The system as claimed in claim 1, wherein the configuration of SSL certificate includes renewal, update, security threat detection and expiry of SSL certificate.

20. A method for automation of SSL certificate lifecycle generation, to eliminate manual processes, fragmentation, insufficient automation, human error, accessibility issues, lack of proactive security, limited customization, the method comprising steps of:
providing data as an input;
guiding the user using AI for filing the CSR in details;
detecting an error in the user's data using AI;
correcting the user by checking the user's input;
submitting the generated one or more CSR based on the correct data received from the user, wherein the platform's AI reviews and optimizes the CSR for security before submission;
issuing of the SSL certificate from the CA upon validation of the CSR;
detecting a user's server environment using AI;
providing optimized SSL configurations using AI;
performing secure installation of SSL certificate on the detected server environment using AI;
performing a penetration testing using AI;
identifying vulnerabilities using AI;
generating an automated report detailing the vulnerabilities;
providing AI-assisted remediation steps for the user to apply to their SSL certificates and server configuration;
monitoring the status of SSL certificates issued to user and vulnerabilities periodically;
initiating the renewal or update based on the detected threat using AI;
updating a user's SSL certificate and server configuration based on the detected threat using AI;
monitoring vulnerabilities or threat periodically;
identifying vulnerabilities or threat;
generating a new cryptographic key using AI;
updating the cryptographic key without causing downtime;
monitoring the status and security of SSL certificate through proactive monitoring using AI, performing checks periodically;
detecting expiration date and vulnerabilities of SSL certificate using AI;
triggering the renewal or update process to maintain security and avoid downtime using AI;
managing user's SSL certificate across multiple platform and server environment;
Providing a unified dashboard to manage SSL certificate across multiple platform and server environment, thereby eliminating manual processes, fragmentation, insufficient automation, human error, accessibility issues, lack of proactive security, limited customization.

21. The method as claimed in claim 20, wherein the data comprising organization name, domain name, public key, organizational unit, country name, state.

22. The method as claimed in claim 20, wherein the error comprising error in organization name, domain name, common name, organizational unit, country name, state.

23. The method as claimed in claim 20, wherein the validation of data include validation of organization name, domain name, public key, organizational unit, country name, state or CSR details.

24. The method as claimed in claim 20, wherein the user includes individuals, companies, firms, businesses.

25. The method as claimed in claim 20, wherein the SSL certificate includes a public key.

26. The method as claimed in claim 20, wherein the optimized SSL configuration includes configuring an SSL certificate according to user's server environment.

27. The method as claimed in claim 20, wherein the automated report includes details of vulnerabilities detected in scan, SSL certificate status, web server and hosting information, actionable insights, wherein vulnerabilities includes self-signed certificates, DNS enumeration (subdomains, DNS records), port scanning (to find open services), web app & SSL scanning (non-intrusive vulnerability detection), email server testing (SPF, DMARC), reconnaissance (headers, certificate analysis), and web server and hosting information includes server type and version, hosting provider, and wherein actionable insights includes risk severity ratings, detailed impact analysis of vulnerabilities, recommended priority for remediation.

28. The method as claimed in claim 20, wherein the AI-assisted remediation steps includes upgrade to a secure protocol (TLS 1.2 or TLS 1.3), Renew certificates, install intermediate certificates, secure hardening recommendations, authentication and authorization enhancements, monitoring and incident response setup, security hardening recommendations.

29. The method as claimed in claim 20, wherein the threat include unauthorized access, cyber-attacks, web server vulnerabilities, wherein unauthorized access includes misconfigured SSL certificates, publicly accessible administration interfaces, cyber-attacks may include MITM attacks, phishing domain detection, DoS vulnerability detection, data interception via insecure protocols, and web server vulnerabilities may include outdated web server configuration, exposed API Endpoints.

30. The method as claimed in claim 20, wherein the proactive monitoring include real time threat detection process and renewal of SSL certificate.

31. The method as claimed in claim 20, wherein the cryptographic key includes public key and private key.

32. The method as claimed in claim 20, wherein the key rotation may be performed as user-initiated rotation, policy-based rotation, seamless transition.

33. The method as claimed in claim 20, wherein the management of SSL certificate includes management of configuration of SSL certificate.

34. The method as claimed in claim 20, wherein the configuration of SSL certificate includes renewal, update, security threat detection and expiry of SSL certificate.
